(19) United States
(12) Patent Application Publication
(10) Pub. No.: US 2026/0320282 A1
(43) Pub. Date: Oct. 15, 2026

(54) MODEL-AGNOSTIC SCHEMA- BASED DOCUMENT PARSING SYSTEM USING LARGE LANGUAGE MODELS

(71) Applicant: EXIMIUS AI, Princeton, NJ (US)

(72) Inventor: Karthikeyan Natarajan, Dayton, NJ (US)

(21) Appl. No.: 19/444,690

(22) Filed: Jan. 9, 2026

Related U.S. Application Data
(60) Provisional application No. 63/743,955, filed on Jan. 10, 2025.

(51) Int. Cl. G06F 40/151; G06F 40/205

(52) U.S. Cl. CPC G06F 40/151; G06F 40/205

(57) ABSTRACT

A model-agnostic system and method for parsing free-form input data into structured JSON outputs using LLMs are provided. The system and method leverage an unconventional Markdown format for schema definition, which optimizes input token usage while maintaining precise output requirements. The system and method ensure predictable JSON outputs by processing free-form data and Markdown schemas through any LLM. Unstructured input data may be enclosed within defined delimiters to enable controlled parsing. The system and method are scalable, flexible, and applicable to diverse data, such as resumes and job descriptions. The disclosed approach operates without optical character recognition, visual analysis, pattern recognition, or model training, and is compatible with multiple commercially available LLMs without retraining. By externalizing data structure definitions into compact Markdown schemas, the system reduces token usage, improves parsing consistency, and enables scalable, real-time processing of heterogeneous documents for downstream integration across enterprise systems.

### PRIORITY CLAIM

This application claims the benefit of provisional application filing No. 63/743,955 entitled “Model-Agnostic Schema-Based Document Parsing System Using Large Language Models”, filed on Jan. 10, 2025.

### BACKGROUND OF THE INVENTION

### Field of Endeavor

The present invention relates to systems and methods for parsing unstructured data into structured outputs, and more particularly, to a schema-driven system for instructing Artificial Intelligence to convert unstructured data into structured outputs. A schema-driven system is a system in which a schema defines output structure and extraction constraints, limits and controls system behavior during execution. Unlike systems in which data extraction behavior is determined by trained statistical models, fixed parsing rules, or visual layout analysis, a schema-driven system constrains or limits output generation through explicit schema definitions that are external to the processing model. The processing model operates in accordance with the schema to produce structured output that conforms to the defined structure and constraints.

### Background of Related Art

In industries such as recruiting and human resources, unstructured data in the form of resumes and/or job descriptions require precise transformation from their unstructured format into at least one structured format for downstream processing.

Existing solutions for parsing unstructured data often fail to handle diverse formats, large-scale datasets, and variations in content effectively.

Existing prior art in the related field are summarized below.
U.S. Pat. No. 11,256,852 B2 entitled “Converting Portions of Documents Between Structured and Unstructured Data Formats”: Focuses on optimizing document data by converting portions of unstructured data into structured formats for querying and storage. This solution uses database level optimization or transformation layers.

The present invention works at the schema and prompt level, directly interacting with Large Language Models (LLMs) via Markdown schemas avoiding database level optimization or transformation layers. It does not rely on backend database architecture.
U.S. Pat. No. 12,183,106 B1 entitled “Methods and Apparatus for Extracting Data from a Document by Encoding it with Textual and Visual Features and Using Machine Learning”: Discusses document parsing using OCR to extract textual and visual data, leveraging machine-learning models.

The present invention avoids Optical Character Recognition (OCR) entirely and interacts directly with LLMs using schema driven prompts. It is model agnostic, requiring no retraining.
U.S. Pat. No. 7,599,952 B2 entitled “System and Method for Parsing Unstructured Data into Structured Data”: Uses statistical models to map and parse unstructured data into structured data, requiring pre-training of the model.

The present invention uses dynamic Markdown schemas to define parsing structures. It does not require pre-training or retraining of statistical models.
U.S. Pat. No. 12,056,443 B1 entitled “Apparatus for Generating Annotations for Electronic Records”: Describes generating annotations on electronic records using machine learning models trained to identify data patterns.

The present invention uses explicit Markdown schemas instead of relying on pre-annotated datasets. It avoids dependency on pre-trained models.
U.S. Patent number 2023/0215206 A1 entitled “Resume Document Parsing Using OCR with Feedback Loop”: Focuses on iterative corrections during resume parsing using OCR technologies and dynamic adjustments.

The present invention eliminates OCR entirely. It uses schema-guided parsing via LLMs, avoiding iterative correction loops.
U.S. Pat. No. 11,163,837 B2 entitled “Text Structure and Content Extraction from Complex Documents”: Extracts content from complex documents into structured repositories for analytics using machine-learning models.

The present invention operates at the schema and prompt level, directly guiding LLMs with Markdown schemas. The backend repository transformation is not required.
U.S. Pat. No. 11,244,203 B2 entitled “Automated Generation of Structured Training Data from Unstructured Documents”: Generates structured training datasets from unstructured documents by applying machine-learning algorithms and visual segmentation.

The present invention operates in real-time without generating training datasets. It avoids visual segmentation entirely.
U.S. Pat. No. 10,489,439 B2 entitled “System and Method for Entity Extraction from Semi-Structured Text Documents”: Extracts entities from text documents using clustering and Machine Learning (ML) techniques. The present invention avoids pattern recognition techniques. It uses schema-first instructions to drive parsing.
U.S. Patent number 2024/0362397 A1 entitled “Machine Learning Based Classification of Resume Paragraphs”: Uses machine learning to classify resume paragraphs based on visual properties and annotations.

The present invention avoids visual-based classification entirely. The Markdown schemas ensure direct and explicit parsing instructions.
U.S. Patent number 20150169510 A1 entitled “Method and System of Extracting Structured Data from a Document”: Employs frequency-based techniques to identify repeating patterns in document layouts for structured extraction.

The present invention uses explicit schema definitions in Markdown. Frequency-based recognition is unnecessary.
U.S. Patent number 20140281938 A1 entitled “Finding Multiple Field Groupings in Semi-Structured Documents” Identifies field groupings within semi structured documents using frequency-based analysis and layout recognition.

The present invention avoids layout dependency. It uses schema-driven rules for field extraction.
U.S. Patent number 20150186847 A1 entitled “Intelligent Tool for Matching Candidates to Job Opportunities”: Describes a system for intelligently matching job applicants with opportunities using structured parsing and matching logic.

The present invention separates data extraction from downstream matching logic. Schema clarity enhances parsing accuracy.
U.S. Patent number 20150269527 A1 entitled “Client-Driven Applicant Tracking System and Method”: Discusses parsing and managing job application data using middleware and tracking systems.

The present invention removes middleware dependencies entirely. It uses schema-first approaches.
U.S. Pat. No. 11,055,327 B2 entitled “System and Method for Automated Parsing of Contact Information”: Extracts contact details from unstructured text using pattern recognition and machine-learning models.

The present invention avoids pattern matching. Uses schema definitions for clarity.
U.S. Pat. No. 11,182,697 B1 entitled “Annotation and Entity Recognition in Unstructured Documents”: Focuses on extracting entities and annotations from unstructured data using pre-trained models.

The present invention uses schema-defined prompts instead of annotated datasets.
U.S. Pat. No. 11,321,956 B1 entitled “Deep Learning-Based Resume Entity Extraction”: Uses deep learning-based models to extract named entities from resumes.

The present invention avoids deep learning dependencies.
U.S. Pat. No. 11,797,755 B2 entitled “Enhanced Document Annotation for Analytics”: Applies machine learning-driven annotations to semi structured and unstructured data for advanced analytics.

The present invention is annotation-free, relying on Markdown schema instructions. As can be seen, the existing patents are inefficient in terms of token usage when working with LLMs, leading to increased computational costs and reduced precision in output. Additionally, these systems are not designed to scale effectively with large datasets, leading to inefficiencies in processing time and accuracy. The inability of these systems to handle variations in input format often results in incomplete or erroneous structured outputs, making them unsuitable for industrial-scale applications. Furthermore, there is a lack of a unified, scalable approach to ensure consistent, structured output for downstream business processes.

There is a need for a model-agnostic schema-driven system for leveraging a Markdown-based schema to guide LLMs in parsing unstructured data, ensuring high precision and consistency while significantly reducing token usage.

The present invention aims to simplify data definitions and reduce dependency on middleware tools. It enables interoperability with commercially available LLMs and optimizes token usage, reducing computational overhead.

### SUMMARY OF THE INVENTION

Aspects of the present invention provide a model-agnostic approach to document parsing by: Defining schemas in an unconventional Markdown style, which clearly specifies output structure and constraints; Using a free-form data input format delimited between special characters, such as ‘\hat{ }’; and Processing the schema and input data with any LLM to produce a predictable JSON output. The present invention provides several technical advantages over existing document parsing systems.

Aspects of the present invention introduce an unconventional Markdown-based schema approach for defining output structures, which significantly reduces token size for input to LLMs while maintaining precision. By combining the Markdown-based schema with a standardized prompt and leveraging the power of LLMs, the system can accurately and consistently parse large-scale datasets comprising millions of resumes and job descriptions into structured JSON formats. This method is scalable, model-agnostic, and cost-efficient, addressing the challenges of diversity, scale, and precision in data parsing.

The present invention introduces a schema-driven approach that interacts dynamically with commercially available LLMs. The reliance on Markdown schemas instead of middleware or retrained Machine Learning (ML) models sets it apart from the cited patents. The patents cited do not address this unique combination of capabilities, and therefore, the invention meets the criteria for novelty, non-obviousness, and industrial applicability. This expanded analysis provides a strong foundation for the invention to advocate for patentability effectively.

In contrast to prior art systems that perform document understanding through visual features, bounding boxes, layout frequency analysis, or ontology-driven extraction pipelines, the present invention leverages the inherent reasoning and language capabilities of LLMs while constraining their output through a compact, human-readable schema. This approach significantly reduces token usage, computational overhead, and system complexity while improving output consistency and scalability.

The invention is model agnostic, enabling seamless interoperability with multiple commercially available LLMs without modification to the underlying system. Because the schema is externalized and expressed in Markdown, changes to output structure or business rules can be achieved without retraining models, modifying databases, or redeploying extraction logic. This provides a technical advantage over prior art systems that are tightly coupled with specific models, visual processing techniques, or backend architecture.

Additionally, the present invention avoids iterative correction loops, annotation generation, and training data synthesis employed by prior art. Instead, precision and consistency are achieved through schema-first instruction, enabling real-time, large-scale parsing of heterogeneous datasets while maintaining predictable structured outputs suitable for downstream enterprise systems.

Accordingly, the present invention introduces a novel and non-obvious paradigm for unstructured data parsing, distinguished from the cited prior art by at least:
(a) the use of an unconventional Markdown-based schema as the primary control mechanism;
(b) elimination of OCR, visual segmentation, and pattern recognition techniques;
(c) real-time operation without training or retraining machine learning models;
(d) significant reduction in token usage and computational cost; and
(e) full model-agnostic interoperability with LLMs.

None of the cited prior art, alone or in combination, teaches or suggests controlling LLM output deterministically through a Markdown-based schema that replaces OCR, visual analysis, model training, and middleware transformation layers.

### BRIEF DESCRIPTION OF THE DRAWINGS

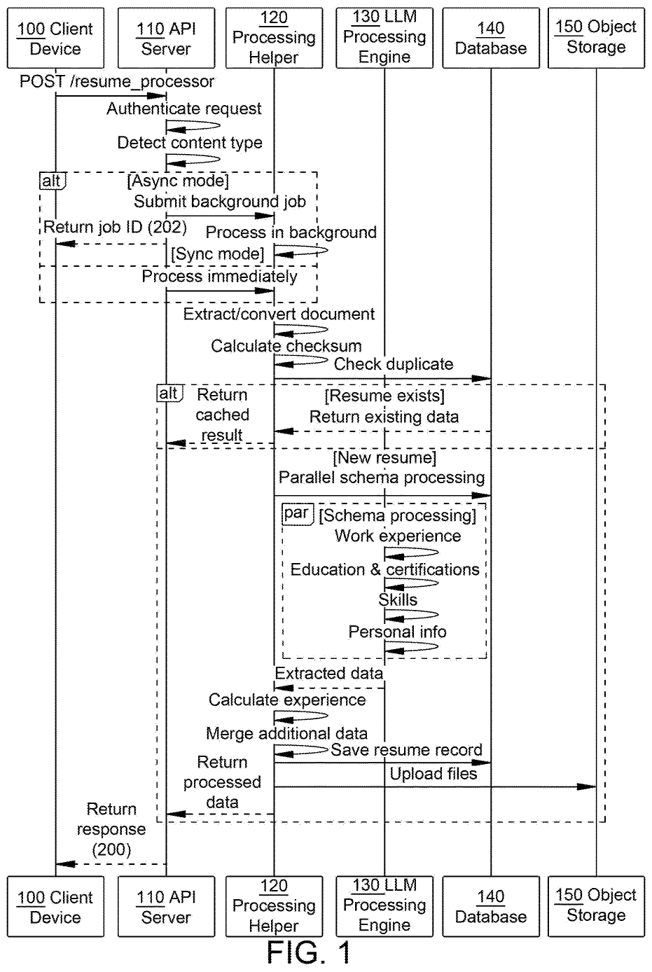

### FIG. 1: Process Flow For Schema-Based Document Parsing

FIG. 1: is a flow diagram illustrating a process for converting unstructured input data into structured output using a schema-driven prompt with any large language model, according to embodiments of the present disclosure.

In the illustrated embodiment, a client device 100 submits unstructured input data, such as a resume or other free-form document, to an API server 110, for example via a request to a document parsing endpoint. The API server authenticates the request and detects a content type of the submitted input data.

Based on the request configuration, the API server 110 may operate in either an asynchronous processing mode or a synchronous processing mode. In the asynchronous mode, the API server submits the request as a background job to a processing helper 120 and returns a job identifier to the client device. In the synchronous mode, the API server forwards the request directly to the processing helper for immediate execution.

The processing helper 120 performs preprocessing operations on the unstructured input data, including extracting or converting the document into text form and calculating a checksum for the extracted content. The checksum is used to query a database 140 to determine whether the input data has been previously processed.

If a matching record is found in the database, indicating that the document already exists, cached structured output may be returned without reprocessing. If the document is determined to be new, the processing helper forwards the extracted text to an LLM processing engine 130 for schema-based parsing.

The LLM processing engine 130 performs parallel schema-based processing in which multiple schemas are applied concurrently to extract different categories of structured information, such as work experience, education and certifications, skills, and personal information. The schema-constrained outputs are returned to the processing helper 120, which may perform additional post-processing operations, including calculating derived values and merging extracted data into a unified structured representation.

The processed structured data is then stored in the database 140, and any associated files or artifacts may be uploaded to object storage 150. Upon completion of processing, the API server 110 returns a structured response to the client device 100. FIG. 1 demonstrates an end-to-end schema-based parsing workflow that supports both synchronous and asynchronous execution, avoids optical character recognition, visual segmentation, and model retraining, and produces deterministic structured output through external schema control of LLM processing.

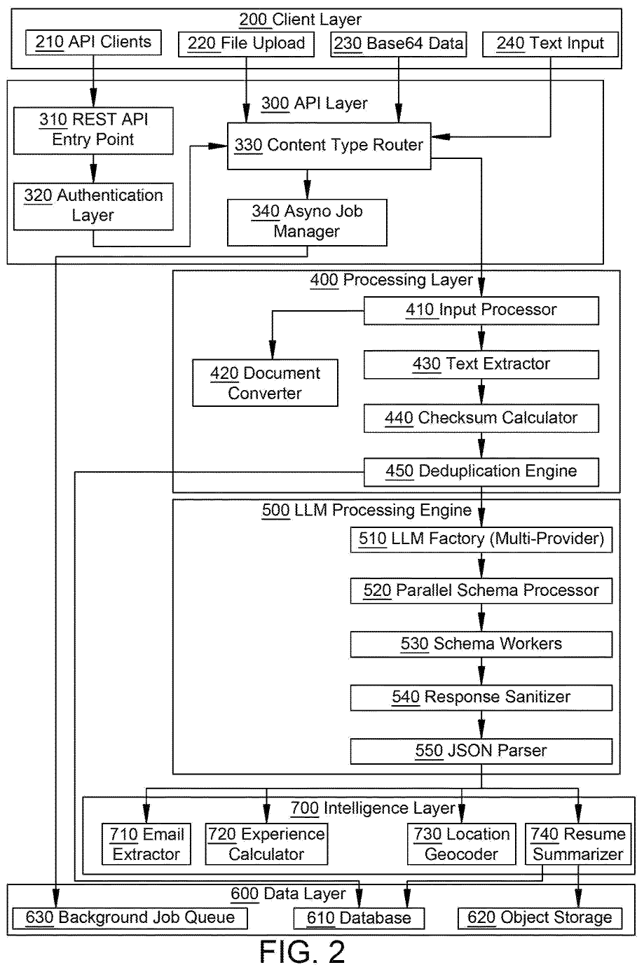

### FIG. 2 System Architecture Diagram

FIG. 2 is a system architecture diagram illustrating an exemplary embodiment of a model-agnostic, schema-based document parsing system, including a client layer, an application programming interface (API) layer, a processing layer, a large language model (LLM) processing engine, and one or more downstream intelligence and data layers, according to aspects of the present disclosure.

In the illustrated embodiment, the system includes a client layer 200 configured to receive unstructured input data from one or more sources, including application programming interface (API) clients 210, file uploads 220, base64-encoded data 230, and direct text input 240. The client layer communicates with an API layer 300 that includes a REST API entry point 310 and an authentication layer 320 for request validation, access control, and routing.

Requests received by the API layer are processed by a content-type router 330, which identifies the format of the incoming input data and forwards the request to an asynchronous job manager 340 for controlled execution. The job manager submits the request to a processing layer 400 responsible for input normalization and preparation.

The processing layer includes an input processor 410 configured to perform document conversion, text extraction, and preprocessing operations. In the illustrated embodiment, the input processor interacts with a document converter 420 and a text extractor 430 to transform the unstructured input into extracted textual content. A checksum calculator 440 and a deduplication engine 450 may be applied to detect duplicate inputs and ensure processing efficiency.

Prepared input data is forwarded to an LLM processing engine_500, which includes an LLM factory 510 configured to select and initialize one or more commercially available LLM providers. The LLM processing engine further includes a parallel schema processor 520, one or more schema workers 530, a response sanitizer 540, and a JSON parser 550. The schema workers apply Markdown-based schemas to execute schema-driven parsing of the unstructured input data, while the response sanitizer and JSON parser validate and enforce schema compliance.

The resulting structured output is provided to an intelligence layer 700, which may include one or more downstream processing modules such as an email extractor 710, an experience calculator 720, a location geocoder 730, and a resume summarizer 740. These modules operate on the structured JSON output without modifying the underlying parsing logic.

Structured data and intermediate results may be persisted within a data layer 600, which includes a database 610, object storage 620, and a background job queue 630 for asynchronous processing and scalability.

FIG. 2 demonstrates a modular, end-to-end system architecture in which unstructured data is transformed into structured output through schema-controlled interaction with LLMs. The architecture is model-agnostic, avoids optical character recognition, visual segmentation, and model retraining, and enables scalable, deterministic parsing suitable for enterprise-grade downstream integration.

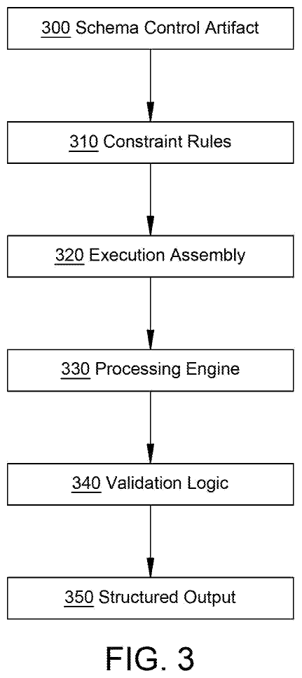

### FIG. 3 Schema-Controlled Execution Framework

FIG. 3 is a block diagram illustrating a schema-control flow for schema-driven parsing of unstructured input data, in which a schema definition specifies output structure and constraints that are incorporated into a prompt assembly and applied during execution by a large language model to produce structured output. FIG. 3 illustrates a conceptual control flow in which a schema operates as an externalized control artifact that constrains output structure and extraction behavior during processing by a large language model. The diagram is illustrative and does not depict literal schema syntax or data content. In embodiments, the schema is defined using an unconventional Markdown based format that specifies output structure, constraints, and normalization rules.

In the illustrated embodiment, a schema control artifact 300 and one or more schema-defined constraint rules 310 are provided as external control mechanisms that govern execution behavior of the LLM independently of model training, statistical inference, visual layout analysis, or pattern recognition techniques. The schema control artifact defines an expected output structure, field definitions, data types, and extraction requirements, while the constraint rules specify enforcement logic for schema compliance.

An execution assembly component 320 combines standardized prompt instructions, the schema control artifact, the schema-defined constraint rules, and delimiter-bounded unstructured input data to form an executable prompt. The executable prompt is submitted to a processing engine 330, which interfaces with a selected LLM to perform schema-constrained processing of the unstructured input data.

The LLM generates a candidate structured output under control of the schema. The candidate output is provided to a validation logic component 340, which evaluates the output against the schema-defined structure and constraints to ensure structural correctness, data consistency, completeness, and compliance with normalization rules.

Upon successful validation, a structured output 350, such as a deterministic JSON representation, is produced and made available for downstream processing, storage, or integration with external systems.

FIG. 3 demonstrates that execution control is achieved through externally defined, Markdown-based schema instructions rather than through retraining of machine-learning models, optical character recognition, visual segmentation, or middleware transformation layers. This schema-controlled execution framework enables model-agnostic interoperability, predictable output generation, and scalable parsing of unstructured data across heterogeneous document formats.

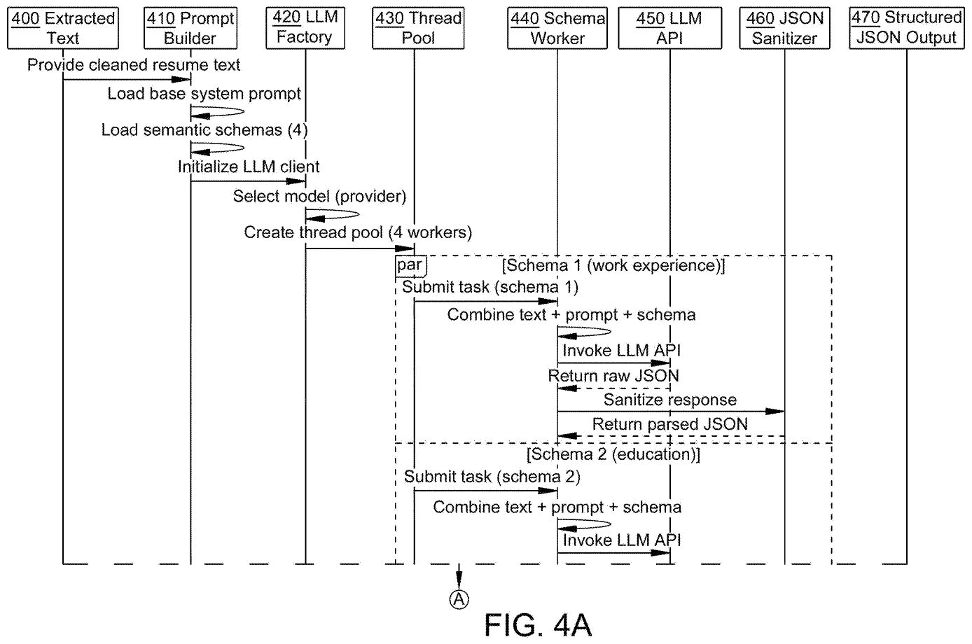

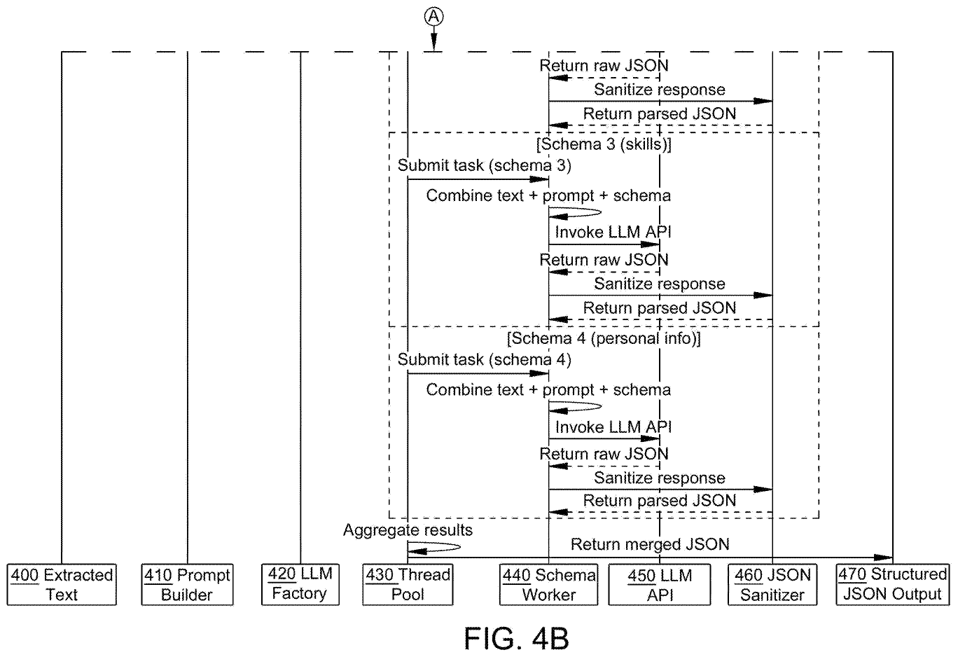

### FIG. 4A: Parallel Schema-Based Prompt Assembly and Execution Flow—First Portion

FIG. 4A is a flow diagram illustrating a first portion of an exemplary parallel schema-based prompt assembly and execution flow, in which multiple schema-specific parsing tasks are initiated for concurrent execution by a large language model, according to embodiments of the present disclosure.

In the illustrated embodiment of FIG. 4A, extracted and pre-processed text data 400 is provided to a prompt builder 410, which loads standardized system prompt instructions and a plurality of schema definitions corresponding to different data categories. The prompt builder initializes an LLM client via an LLM factory 420, which selects a commercially available LLM provider in a model-agnostic manner.

A thread pool 430 is created to enable parallel execution of multiple schema-specific tasks. Each task corresponds to a distinct schema and is submitted concurrently to one or more schema workers 440. In FIG. 4A, a first schema task for work experience and a second schema task for education are shown. For each schema task, the schema worker combines the extracted text, standardized prompt instructions, and a respective schema definition to assemble a schema-specific executable prompt.

Each assembled prompt is submitted to the LLM through an LLM application programming interface (API) 450, which returns a raw structured response. The raw response is passed to a JSON sanitizer 460, which performs validation, normalization, and enforcement of schema-defined structural and constraint rules. FIG. 4A shows the first schema task returning parsed JSON and shows the second schema task continuing through connect A to FIG. 4B.

FIG. 4A demonstrates initiation and partial execution of concurrent schema-based parsing tasks using parallel prompt assembly and LLM invocation. In an illustrated example, multiple schema workers process different categories of information in parallel, such as work experience, education, skills, and personal information. The validated structured outputs produced by the individual schema workers are aggregated to form a merged structured JSON output 470.

FIG. 4B: Parallel Schema-Based Prompt Assembly and Execution Flow Second Portion. FIG. 4B is a flow diagram illustrating a second portion of the parallel schema-based prompt assembly and execution flow of FIG. 4A, including continued execution of the second schema task, additional schema-specific tasks, aggregation of results, and return of a merged structured JSON output.

In the illustrated embodiment of FIG. 4B, execution continues from connector A. The second schema task for education returns raw JSON, passes the response through the JSON sanitizer 460, and returns parsed JSON. Additional schema workers perform a third schema task for skills and a fourth schema task for personal information. Each additional schema worker combines the extracted text, standardized prompt instructions, and the respective schema definition, invokes the LLM API 450, sanitizes the raw JSON response, and returns parsed JSON.

After the parallel schema workers complete, the thread pool 430 aggregates results. The structured JSON output component 470 returns a merged JSON output.

The combination of FIG. 4A and FIG. 4B collectively demonstrates that schema-based parsing tasks can be executed concurrently using parallel prompt assembly and LLM invocation, thereby improving throughput, scalability, and processing efficiency while maintaining deterministic, schema-constrained structured output. The parallel execution flow operates without optical character recognition, visual layout analysis, model retraining, or middleware transformation layers, and supports model-agnostic interoperability with multiple LLM providers.

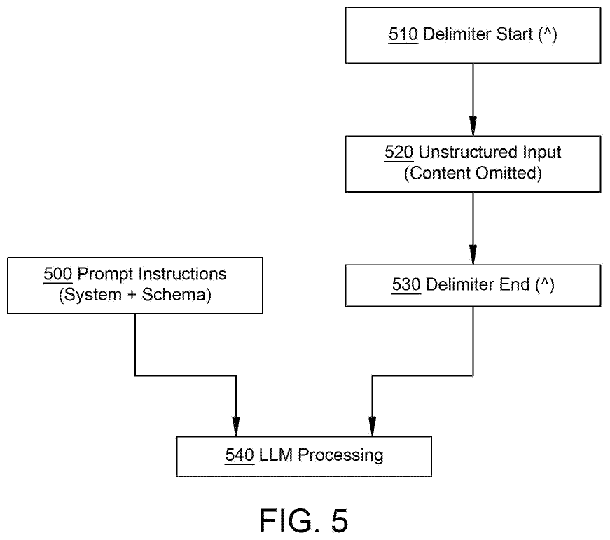

### FIG. 5: Delimiter-Bounded Input Structure Diagram

FIG. 5 is a conceptual diagram illustrating delimiter-bounded unstructured input data, in which one or more defined delimiter markers are used to explicitly bound free-form input data and separate the input data from prompt instructions and schema definitions prior to processing by a large language model.

In the illustrated embodiment, one or more standardized prompt instructions 500, including system instructions and schema definitions, are maintained separately from the unstructured input data to be parsed. The unstructured input data 520, which may comprise free-form text extracted from a document, is explicitly enclosed between a defined delimiter start marker 510 and a defined delimiter end marker 530.

The delimiter start marker 510 and delimiter end marker 530 establish clear boundaries around the unstructured input data 520, thereby isolating the content to be parsed from the prompt instructions and schema definitions. In one embodiment, the delimiter markers may comprise special characters, such as caret symbols (“\hat{ }”), although other delimiter symbols or token sequences may be used without departing from the scope of the invention.

Both the delimiter-bounded unstructured input data and the prompt instructions 500 are provided to an LLM processing component 540. During execution, the LLM is instructed to process only the content enclosed within the delimiter markers in accordance with the schema-defined constraints, while treating the prompt instructions and schema definitions as external control logic.

FIG. 5 demonstrates that delimiter-bounded input separation improves parsing reliability by reducing ambiguity, preventing unintended interpretation of prompt instructions as data, and enforcing controlled execution of schema-driven parsing. This delimiter-based structure enables predictable, deterministic generation of structured output without reliance on optical character recognition, visual segmentation, pattern recognition, or model retraining.

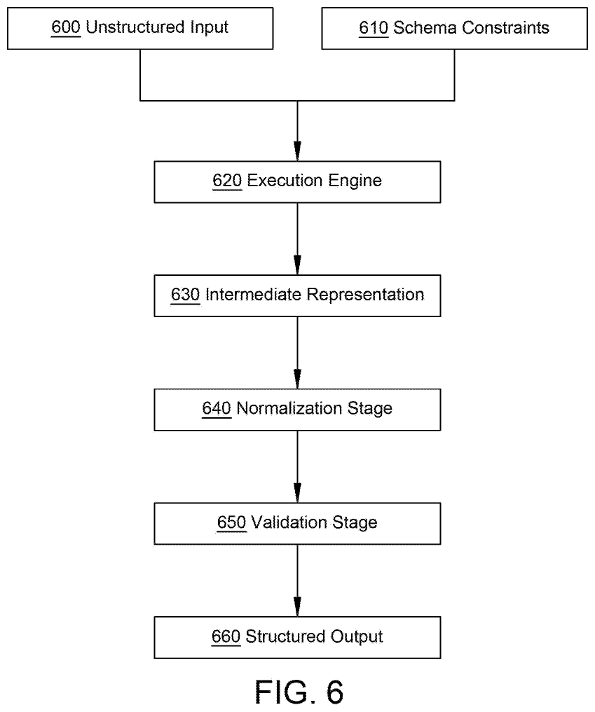

### FIG. 6: Multi-Stage Schema-Driven Transformation Pipeline

FIG. 6 is a block diagram illustrating a transformation process in which schema constraints are applied during large language model processing to generate validated structured output, including normalization and validation stages performed after schema-constrained execution.

FIG. 6 illustrates a conceptual transformation process rather than a specific data instance. The illustrated stages represent logical processing phases in which schema defined constraints are applied during execution by a large language model, followed by normalization and validation of structured output. The figure is not intended to limit the invention to a particular data format or field level.

In the illustrated embodiment, unstructured input data 600 is received by an execution engine 620 together with one or more schema constraints 610. The schema constraints define an expected output structure, field definitions, data types, and extraction rules that externally govern processing behaviour of a large language model (LLM), independent of model training, statistical inference, or visual layout analysis.

The execution engine 620 processes the unstructured input data in accordance with the schema constraints to generate an intermediate representation 630. The intermediate representation may comprise partially structured data elements extracted from the unstructured input under control of the schema.

The intermediate representation 630 is provided to a normalization stage 640, which applies schema-defined normalization rules, including formatting, standardization, semantic alignment, and value transformation, to ensure consistency with the schema specifications. The normalized data is then provided to a validation stage 650, which enforces schema compliance by verifying structural correctness, completeness, data type conformity, and constraint satisfaction.

Upon successful validation, the system produces a structured output 660, such as a JSON document, that conforms deterministically to the schema and is suitable for downstream processing, storage, or integration with external systems.

FIG. 6 demonstrates that structured output generation is achieved through a controlled, multi-stage pipeline driven by external schema definitions rather than by retrained models, optical character recognition, visual segmentation, or middleware transformation layers, thereby enabling model-agnostic, scalable, and cost-efficient parsing of unstructured data.

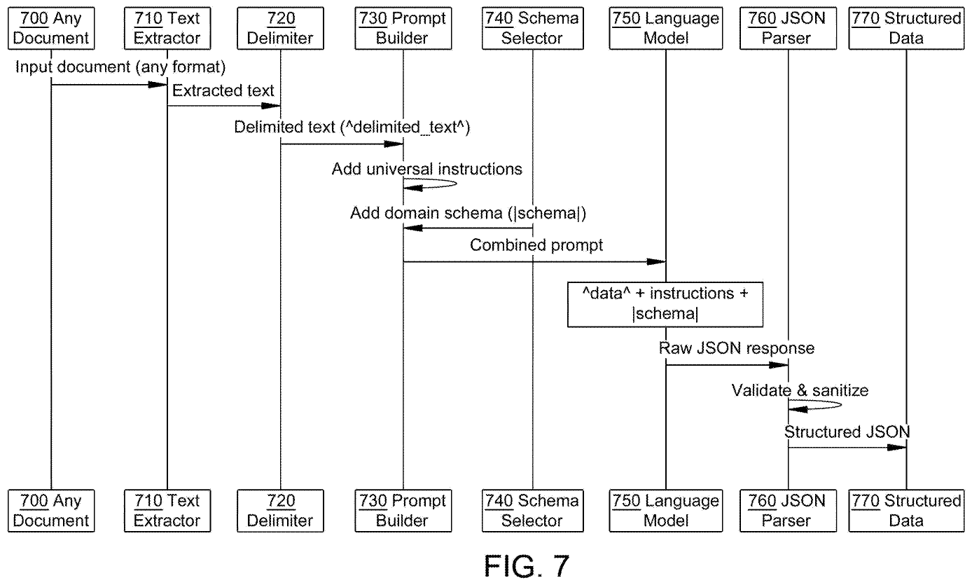

### FIG. 7: Prompt Instruction Structure

FIG. 7 is a diagram illustrating an exemplary prompt structure for schema-based parsing, including standardized system instructions, delimiter-bounded unstructured input data, and a schema defined in a Markdown-based format, which are combined to form a prompt provided to a large language model.

In the illustrated embodiment, any document 700, which may be in any electronic format, is provided to a text extraction component 710 configured to convert the document into extracted textual content. The extracted text is then provided to a delimiter component 720, which encloses the extracted text within one or more defined delimiter markers to explicitly bound the unstructured input data.

The delimiter-bounded text is provided to a prompt builder 730, which assembles a combined prompt by incorporating standardized prompt instructions together with the delimiter-bounded unstructured input data. The standardized prompt instructions define general execution behavior and processing rules applicable across parsing tasks. A schema selector 740 selects one or more domain-specific schemas defined in a Markdown-based format. The selected schema specifies an expected output structure, field definitions, data types, and extraction constraints. The prompt builder 730 combines the standardized instructions, the delimiter-bounded input data, and the selected schema to generate a combined prompt.

The combined prompt is provided to a language model 750, which processes the unstructured input data in accordance with the schema-defined constraints to generate a raw JSON response. The raw JSON response is provided to a JSON parser 760, which validates, sanitizes, and enforces schema compliance to produce structured data 770. The resulting structured data 770 conforms deterministically to the schema and is suitable for downstream processing, storage, or integration with external systems.

FIG. 7 demonstrates that prompt assembly and execution are controlled through external, schema-based instructions and delimiter-bounded input data rather than through model retraining, optical character recognition, visual segmentation, or middleware transformation layers. This structure enables model-agnostic, predictable, and scalable generation of structured output from unstructured documents.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a system and method for processing unstructured data into structured data outputs. Embodiments of the present invention take a first input, such as free-form data, such as resumes, job descriptions, or other digital documents, which can be enclosed in one or more special characters, such as ‘\hat{ }’. Embodiments, of the present invention takes a second input, such as a Markdown-based Schema, which can be a schema, formatted in an unconventional Markdown style, specifying the output format, element types, and extraction rules. Embodiments of the present invention process the first input utilizing the second input and at least one LLM. The second input acts as a guide to the LLM in extracting and structing data from the first input, to provide as output one or more JSON documents.

Advantageously, embodiments of the present invention utilize a Markdown format for schema definition. While Markdown is traditionally used for documentation, its use for schema definition offers significant advantages, such as: Token Optimization which reduces input token size when submitted to LLMs, enhancing cost efficiency and performance; Maintains clarity and precision in defining complex output structures; and Simplifies schema creation and validation for technical and non-technical users. Additionally, this unconventional and unique approach ensures that LLMs generate outputs that are precise, predictable, and structured strictly according to the schema.

FIG. 1 illustrates a process flow for converting unstructured data to structured data, according to aspects of the present invention. In embodiments, the process can involve a client device 100, an API server 110, a processing helper 120, an LLM processing engine 130, a database 140, and object storage 150. The process can include one or more components or operations, such as, but not limited to: at least one Markdown Schema for defining a structure of an output and ensuring consistent, precise output; and at least one prompt instruction(s) for guiding at least one LLM in processing the data.
Preprocessed Data: Ensures input compatibility and reduces errors.
Validation Logic: Checks JSON output against schema requirements.

The process of FIG. 1 can begin with reception of one or more unstructured documents from one or more channels. In embodiments, the one or more unstructured documents can be one or more resumes, job descriptions, or other digital content. In embodiments, the one or more channels can include emails, Applicant Tracking Systems (ATS), Human Resources Information Systems (HRIS), Job Boards, Internal ATS, Customer ATS, Vendor Management Systems (VMS), etc.

Once the one or more unstructured documents are received, they can be prepared for processing. In embodiments, preparation for processing can include preprocessing of one or more unstructured documents. In embodiments, preprocessing can include normalizing formats, removing redundant or irrelevant data, and extracting relevant fields from the one or more unstructured documents. Advantageously, normalization ensures the one or more unstructured documents are in a format compatible with a schema and one or more LLMs.

After preprocessing, one or more prompt assembly processes may be performed. In some embodiments, the prompt assembly processes include generating a system prompt and generating a user prompt. The system prompt may be assembled by combining one or more standardized instructions with a schema that defines parsing requirements, including an output format and one or more constraints. The standardized instructions may guide a large language model (LLM) in processing unstructured data in accordance with the schema. In some embodiments, the schema is provided in a Markdown-based format. The schema may define one or more output data structures and one or more constraints applicable to the unstructured data. Additionally, the user prompt may include the preprocessed unstructured data embedded within one or more delimiter characters, such as a caret symbol (“\hat{ }”), to distinguish the unstructured data from the standardized instructions.

After prompt assembly, one or more system prompts, and one or more user prompts can be provided to an LLM of the user's choice, along with the schema. In embodiments, the LLM can utilize the schema to interpret the combined system and user prompts. In embodiments, the LLM can apply the schema's constraints to generate structured JSON output.

After processing by the LLM resulting in at least one structured JSON output, the at least one structured JSON output can be validated. In embodiments, the at least one output can be validated against the schema. In embodiments, the validated JSON output can be integrated into downstream systems, such as ATS systems, analytics platforms, or job-matching engines.

After at least one validated JSON output is provided, an optional feedback step can occur. In embodiments, feedback can refine the schema and prompt instructions based on real-world performance. This ensures adaptability to new formats and enhances parsing accuracy.

Embodiments of the present invention enable a user to interact with the system through a graphical interface or Application programming interface (API), automating most of the steps above. It can handle diverse datasets, generate consistent results, and integrate seamlessly into existing systems, solving the problem of unstructured data parsing efficiently and reliably.

In embodiments, steps or components of the method and system can be reordered or otherwise modified. For example, the order of some steps, such as data preprocessing and schema preparation, can be interchanged depending on the type of input data. The system and method invention are model agnostic, so the LLM used for processing can be swapped with any compatible model without affecting the overall process. The Markdown schema can be reconfigured to accommodate different data types (e.g., academic records, financial data) by altering field definitions and constraints. Additionally, instead of direct integration into ATS systems, the output could be routed through a middleware platform for additional processing.

The present invention can be adapted for multiple fields that involve unstructured data processing, such as:
Healthcare: Parsing patient records or insurance claims into structured formats;
Finance: Extracting and structuring data from invoices, contracts, or transaction records;
Education: Standardizing and processing academic records or student applications; and/or
Legal: Analyzing and structuring legal contracts or case summaries. By customizing the Markdown schema and prompt instructions, the system can be tailored to solve similar problems across various industries.

Embodiments of the present invention can include a plurality of product such as, but not limited to:
Structured JSON Outputs: These outputs serve as highly accurate and standardized data representations of resumes, job descriptions, or other unstructured data. Use cases include feeding data into applicant tracking systems (ATS), analytics tools, or business intelligence platforms.
Data Transformation Modules: Modularized tools for preprocessing and validating data based on schema-defined constraints. These modules can be reused across various industries to normalize and structure unstructured datasets.
Integration Pipelines: Custom-built pipelines for seamlessly integrating structured outputs into existing systems (e.g., ATS, HRIS, or CRM platforms). These pipelines reduce the need for manual intervention during data ingestion.
Adaptable Schema Libraries: A collection of pre-defined Markdown schemas for processing different types of data, such as resumes, contracts, invoices, or academic records. These libraries can be customized to meet industry-specific needs.
Interactive User Interfaces: A user-friendly interface for managing data inputs, creating custom schemas, and validating JSON outputs. This tool allows non-technical users to leverage the invention's capabilities without coding expertise.

It should be understood, of course, that the foregoing relates to exemplary embodiments of the invention and that modifications may be made without departing from the spirit and scope of the invention as set forth in the following claims.

What is claimed is:

1. A system for parsing unstructured data into structured data using an LLM, comprising:
a processor;
a memory storing instructions that, when executed by the processor, cause the system to:
receive unstructured input data enclosed within one or more defined delimiters;
access a schema defined in a Markdown-based format, the schema specifying an output data structure and one or more extraction constraints;
assemble a system prompt by combining the schema with standardized prompt instructions;
provide the system prompt and the unstructured input data to a selected LLM; and
receive, from the LLM, a structured output in JSON that conforms to the schema.

2. The system of claim 1, wherein the Markdown-based schema reduces token usage when processed by the LLM while maintaining output precision.

3. The system of claim 1, wherein the LLM is selected from a plurality of commercially available LLMs without retraining.

4. The system of claim 1, wherein the schema specifies rules for handling abbreviations, semantic equivalents, logical variations, and data normalization.

5. The system of claim 1, further comprising validating the structured output against the schema prior to downstream integration.

6. The system of claim 1, further comprising preprocessing the unstructured input data prior to prompt assembly.

7. A method for parsing unstructured, free-form data into structured JSON format using LLMs, comprising:
Providing input data enclosed within defined delimiters;
Defining a schema in a Markdown-based format that specifies data structure and constraints;
Combining the schema with prompt instructions to assemble a system prompt;
Sending the system prompt and user prompt to an LLM; and
Generating a structured JSON output from the LLM based on the schema.

8. The method of claim 7, further comprising a non-transitory computer-readable medium storing instructions.

9. The method of claim 7, wherein the Markdown-based schema reduces token usage when processed by the large language model while maintaining output precision.

10. The method of claim 7, wherein the method is performed using different large language models without modification to the schema.

11. The method of claim 7, wherein the schema specifies rules for handling abbreviations, semantic equivalents, logical variations, and data normalization.

12. The method of claim 7, further comprising integrating the structured JSON output into an applicant tracking system, analytics platform, or matching engine.

13. The method of claim 7, further comprising refining the schema or standardized prompt instructions based on parsing performance feedback.

14. The method of claim 7, wherein the unstructured input data comprises resumes, job descriptions, contracts, invoices, medical records, academic records, or legal documents.
